(19) United States
(12) Patent Application Publication
(10) Pub. No.: US 2019/0392960 A1
(43) Pub. Date: Dec. 26, 2019

(54) SYSTEMS AND METHODS FOR NUCLEAR MATERIAL STORAGE CONTAINERS THAT ARE CHLORIDE-INDUCED STRESS CORROSION SUSCEPTIBLE

(71) Applicant: NAC International Inc., Norcross, GA (US)

(72) Inventors: Jay G. Wellwood, Peachtree Corners, GA (US); George C. Carver, Norcross, GA (US)

(21) Appl. No.: 16/222,185

(22) Filed: Dec. 17, 2018

Related U.S. Application Data
(60) Provisional application No. 62/687,483, filed on Jun. 20, 2018.

(51) Int. Cl. G21F 1/06; G21F 5/06; G21F 1/08

(52) U.S. Cl. CPC G21F 1/06; G21F 1/085; G21F 5/06

(57) ABSTRACT

In one aspect, the disclosure relates to storage systems comprising a protective barrier to chemical attack, e.g. to chloride-induced stress corrosion cracking (CISCC). Moreover, the disclosed protective barriers can provide enhanced protection to or otherwise shield against general corrosion. In a further aspect, the disclosed protective barriers have minimal activity as catalysts for galvanic corrosion. The present disclosure further pertains to methods of applying the disclosed protective barriers to the disclosed storage systems. In various aspects, the disclosed storage systems are used for the storage of nuclear material. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 62/687,483, filed on Jun. 20, 2018, which is incorporated herein by reference in its entirety.

### BACKGROUND

Worldwide generation of nuclear energy is expected to grow from around 2.3 billion kilowatt hours in 2012 to about 4.5 billion kilowatt hours in 2040. In 2015, there were 448 nuclear power reactors in operation globally. Of the currently operating nuclear power plants, 99 are located in the United States, making it the largest nuclear power generating country in the world. Accordingly, the United States produces the greatest fraction of nuclear waste globally. The nuclear waste comprises very low-level (“VLLW”), low-level (“LLW”), intermediate-level (“ILW”), and high-level waste (“HLW”) streams. The International Atomic Energy Agency estimates that, as of 2018, the total inventory for each of these waste streams was, respectively, 2,356,000 m³, 3,479,000 m³, 460,000 m³, and 22,000 m³. In addition to radioactive waste, other nuclear materials are produced for use in the research and medical industries. Accordingly, long-term storage of nuclear material in a safe manner is an ever increasing need in the industry.

Nuclear fuel discharged from fission reactors, referred to hereinafter as Spent Nuclear Fuel (“SNF”), is typically stored in deep pools filled with water, with the water being provided to dissipate heat and to attenuate gamma and neutron radiation generated by the SNF. As an alternative to storing SNF in water-filled pools (“wet storage”), “dry storage” techniques also have been utilized. In a typical dry storage application, the SNF is stored in a substantially horizontal or substantially vertical configuration within a protective vessel, such as a “cask” or “overpack,” which typically includes a heavy-walled structure. Additionally, the SNF may be stored in a thin-walled vessel (referred to hereinafter as a canister) which then may be placed into a cask. Such dry storage applications are widely viewed as possessing the necessary characteristics to enable economical long-term storage of SNF.

Chloride-induced stress corrosion cracking (“CISCC”) is a type of degradation in certain types of stainless steel materials that results in cracks in the material. Although the phenomenon is very common in submerged water environments, CISCC can degrade materials in open-air environments as well. Three conditions must exist before CISCC can initiate and propagate on a surface of a stainless steel material: (a) the stainless steel material is of a type with metallurgical properties that make it susceptible to CISCC; (b) the presence of a tensile stress acting on the stainless steel material; and (c) the stainless steel material is located in an environment conducive to CISCC. In general, stainless steel materials that comprise an austenitic stainless steel, such as SAE type 304 and type 316 steel materials, are susceptible to CISCC. The presence of a tensile stress can be an active or a residual tensile stress. For example, stainless steel canisters for the storage of nuclear material, e.g., SNF, can have residual tensile stresses near welds in the canister body. With regard to the environmental conditions, factors that may lead to CISCC include the presence of chloride salts, e.g., NaCl, MgCl₂, and/or CaCl₂, a favorable temperature range, and a favorable relative humidity range.

Once the three basic conditions are met for CISCC, it is conceivable for CISCC to initiate on the surface of a stainless steel canister containing nuclear material, e.g., SNF. For example, chloride salts can absorb moisture from the air to form an aqueous chloride-rich solution (a process called deliquescence). The chloride-rich solution chemically can attack stainless steel material in regions of high tensile stress. For a given salt type, the absorption of moisture can occur only in specific ranges of temperature and relative humidity, and those ranges are different for each salt type. It is common for stainless steel canisters containing nuclear material, e.g., SNF, to be stored in open-air conditions in which the suitable temperature and relative humidity can occur.

CISCC is more likely to be initiated in a pre-existing crevice, crack, or flaw, such as a pit caused by localized corrosion. Once a crack has started, it will continue to advance through the crystalline structure of the stainless steel as long as the necessary conditions of temperature, tensile stress, and presence of a chloride-rich solution remain. Other factors affecting the initiation and progression of CISCC are the type of stainless steel used in fabricating the canister and the fabrication technique itself (e.g., amount of cold working, annealing). The process of CISCC can conceivably lead to pits and cracks that result in breach of stainless steel container.

Despite advances in research directed to maintaining the integrity of stainless steel canisters used for nuclear material storage systems, e.g., SNF, there remains a need for improved storage systems comprising protective barriers that enhance resistance to CISCC. Moreover, there is a need for methods to provide protective barriers that enhance resistance to CISCC in both the field, e.g., retroactively applied to existing nuclear material storage system containing nuclear material, and for new storage systems at the time of manufacture. Ideally, the protective barrier provided for enhanced resistance to CISCC would further provide enhanced resistance to general corrosion effects and would also not be a catalyst for galvanic corrosion. These needs and other needs are satisfied by the present disclosure.

### SUMMARY

In accordance with the purpose(s) of the present disclosure, as embodied and broadly described herein, the disclosure, in one aspect, relates to storage systems comprising a protective barrier that has improved resistance to CISCC. Moreover, the disclosed protective barriers can provide enhanced resistance to general corrosion. In a further aspect, the disclosed protective barriers have minimal activity as catalysts for galvanic corrosion. The present disclosure further pertains to methods of applying the disclosed protective barriers to a stainless steel canister or container for storage of nuclear material. In a still further aspect, the present disclosure pertains to articles comprising stainless steel storage containers for nuclear material comprising the disclosed protective barriers.

In an aspect, the present disclosure pertains to methods for providing a protective coating to a storage system for storing nuclear material, the method comprising: depositing at least one layer of a CISCC-resistant coating material on a substrate; wherein the substrate is a surface of the storage system for storing nuclear material; wherein the CISCC-resistant coating material comprises a compatible metal powder, a compatible metal particulate, or combinations thereof; and wherein the depositing utilizes a ballistic impingement process.

In a further aspect, the present disclosure pertains to methods for providing a protective coating to a storage system for storing nuclear material, the method comprising: depositing at least one layer of a CISCC-resistant coating material on a substrate; wherein the substrate is a surface of the storage system for storing nuclear material; wherein the CISCC-resistant coating material comprises (a) a compatible metal powder, a compatible metal particulate, or combinations thereof; and (b) a hard phase material; and wherein the depositing utilizes a ballistic impingement process.

In an aspect, the present disclosure pertains to storage systems comprising a component made by a disclosed method.

In a further aspect, the present disclosure pertains to storage systems comprising a component made by a disclosed method, and wherein the storage system is a storage system for storing nuclear material.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flow diagram depiction a functional representation of a preferred embodiment of the present invention.

FIGS. 2A and 2A show a cross-sectional, cut-away views of a representative substrate with a CISCC-resistant coating formed by a disclosed method. FIG. 2A shows a cross-sectional, cut-away views of a representative substrate with a single layer of a CISCC-resistant coating formed by a disclosed method. FIG. 2B shows a cross-sectional, cut-away views of a representative substrate with three layers of a CISCC-resistant coating formed by a disclosed method.

FIG. 3 is a representative photographic image of a representative CISCC-resistant material 12 on a representative substrate 11 made by a disclosed method.

FIG. 4 is a representative photographic image of a representative CISCC-resistant material 12 on a representative substrate 11 made by a disclosed method.

FIG. 5 is a representative photographic image of a representative CISCC-resistant material 12 on a representative substrate 11 made by a disclosed method. The layer of the CISCC-resistant material is about 20 microns thick.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a coating,” “a substrate,” or “a canister,” including, but not limited to, two or more such coatings, substrates, or canisters, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a coating refers to an amount that is sufficient to achieve the desired improvement in the property modulated by the formulation component, e.g., achieving the desired level of resistance to chloride-induced stress corrosion cracking (“CISCC”). The specific level in terms of wt % or thickness of a coating required as an effective amount will depend upon a variety of factors including the intended use environment, cost, degree of resistance to CISCC required, and end use of the storage system made using the disclosed methods.

As used herein, the term “nuclear material” includes nuclear fuel materials; spent nuclear fuel; fission products (including both direct and indirect fission products); nuclear fuel materials; fissile material; fissionable material; radioactive waste; radioactive materials; and any material containing an actinide, regardless of whether it can be used as a nuclear fuel. The term is meant to include materials that may be deemed as nuclear materials by the United States Atomic Energy Act of 1954. Nuclear material can include, but is not limited to, plutonium, uranium-233, uranium-235, uranium enriched in the uranium-233 or uranium-235 isotopes; as well as radioactive fission product nuclides such as, but not limited to, tritium, barium-130, cesium-141, zirconium-95, iodine-131, and iodine-125. Other examples of nuclear materials include spent fuel, depleted uranium, yellowcake, uranium dioxide, metallic uranium with zirconium and/or plutonium, thorium dioxide, thorianite, uranium chloride salts such as salts containing uranium tetrachloride and/or uranium trichloride.

As used herein the term “fissile material” is defined as any material fissionable by thermal (slow) neutrons. The three primary fissile materials are uranium-233 (²³³U), uranium-235 (²³⁵U) and plutonium-239 (²³9Pu). U-238 (²³⁸U) is fissionable by more energetic particles.

As used herein, “fissionable material” means any nuclide capable of undergoing fission when exposed to low-energy thermal neutrons or high-energy neutrons. In some instances, the term “fissionable” refers to materials in which fission may be induced by energies of about 20 MeV or less. Hence uranium-233 (²³³U), uranium-235 (²³⁵U), plutonium-239 (²³⁹Pu), and U-238 (²³⁸U) are “fissionable.” Fissionable material includes any nuclide capable of undergoing fission when exposed to low-energy thermal neutrons or high-energy neutrons. Furthermore, fissionable material includes any fissile material, any fertile material or combination of fissile and fertile materials. A fissionable material may contain a metal and/or metal alloy. In one embodiment, the fuel may be a metal fuel. It can be appreciated that metal fuel may offer relatively high heavy metal loadings and excellent neutron economy, which is desirable for breed-and-burn process of a nuclear fission reactor. Depending on the application, fuel may include at least one element chosen from U, Th, Am, Np, and Pu. In one embodiment, the fuel may include at least about 90 wt. % U—e.g., at least 95 wt. %, 98 wt. %, 99 wt. %, 99.5 wt. %, 99.9 wt. %, 99.99 wt. %, or higher of U. The fuel may further include a refractory material, which may include at least one element chosen from Nb, Mo, Ta, W, Re, Zr, V, Ti, Cr, Ru, Rh, Os, Ir, and Hf. In one embodiment, the fuel may include additional burnable poisons, such as boron, gadolinium, or indium. In addition, a metal fuel may be alloyed with about 3 wt. % to about 10 wt. % zirconium to dimensionally stabilize the fuel during irradiation and to inhibit low-temperature eutectic and corrosion damage of the cladding.

The term ‘fission product’ as used herein refers to those elements formed as direct products (or so-called ‘fission fragments’) in the fission of nuclear fuel and products formed from such direct products by beta decay or internal transitions. Fission products include elements in the range from selenium to cerium. Fission products include elements in the range from selenium to cerium including elements such as ₅₆Ba, ₄₀Zr and ₅₂Te, ₅₅Cs and ₅₈Ce.

As used herein, a “direct fission product” refers to an atom that remains after fission of a fissile atom.

As used herein, an “indirect fission product” refers to a decay daughter, grand-daughter, etc., that results from the radioactive decay of a direct fission product. However, at any given point in time, some quantity of a particular species fission product compound, such as ⁹⁹Mo, will be a direct product and the remaining quantity will be indirect products, as there can be multiple decay chains at work.

As used herein, “nuclear fuel material” is intended to cover the various materials used as nuclear fuels for nuclear reactors including ceramic compounds such as oxides of uranium, plutonium and thorium with particularly preferred compounds being uranium oxide, plutonium oxide, thorium oxide and mixtures hereof.

As used herein, “radioactive material” refers to any substance that gives off various types of radiation in the form of electrons, neutrons, protons, alpha-particles, high energy-photons, gamma rays, or a mixture of two or more of these. Alpha radioactivity, a positively charged particle, corresponds to the emission of a helium nucleus, a particularly stable structure consisting of two protons and two neutrons, called an alpha particle. Beta radioactivity corresponds to the transformation, in the nucleus: either of a neutron into a proton characterized by the emission of an electron (e−) or of a proton into a neutron, characterized by the emission of an anti-electron or positron (e+). It only appears in artificial radioactive nuclei produced by nuclear reactions. Gamma radioactivity, unlike the other two, is not related to a transmutation of the nucleus. It results in the emission, by the nucleus, of an electromagnetic radiation. Gamma radioactivity can occur by itself or together with alpha or beta radioactivity.

As used herein, “radioactive waste” refers to waste that contains radioactive material. Radioactive waste is typically a by-product of nuclear power generation, or is produced from the use of radioactive materials in scientific research, industrial, agricultural and medical applications, and the production of radiopharmaceuticals. Furthermore, in the mining industry, radioactive waste arises from naturally occurring radioactive materials (NORM) that are concentrated as a result of the processing or consumption of coal, oil and gas, and some minerals. For example, coal contains a small amount of radioactive uranium, barium, thorium and potassium, and residues from the oil and gas industry often contain radium and its decay products. In some instances, radioactive waste can refer to material containing the unusable radioactive by-products of the scientific, military, medical and industrial applications of nuclear energy.

As used herein, “low-level radioactive waste” refers to low level radioactive material as defined by Nuclear Regulatory Commission Regulations (“NRC”) set forth in 10 CFR 61. Low level radioactive wastes do not include spent nuclear fuel, transuranic waste or byproduct materials which are defined as high-level radioactive wastes in § 11 e(2) of the Atomic Energy Act of 1954 at 43 U.S.C. 2014 (e). Low-level radioactive wastes (“LLW”) include radioactive material found in evaporator concentrate, ion exchange resins, incinerator bottom ash, filtration sludges, and contaminated filters and membranes. Cs-137, Co-57 and Sb-125 are common radioactive constituents.

As used herein, “radioactive high level waste” refers to radioactive material which has a half-life in excess of 200,000 years. High level waste (HLW) is typically produced by nuclear reactors. It contains fission products and transuranic elements generated in the reactor core. HLW has high levels of activity that generate significant quantities of heat by radioactive decay that need to be considered in the design of a disposal facility. Disposal in deep, stable geological formations usually several hundreds of meters below the surface is generally recognized as the most appropriate option for HLW. The two primary classes of civilian HLW are used fuel from nuclear power reactors and separated waste arising from the reprocessing of that used fuel.

As used herein, the term “pre-service unit” means a storage system, canister, cask or container for storing nuclear material at or immediately following the time of fabrication of the system or container such that the system or container has not been previously used or currently used to store nuclear material.

As used herein, the term “in-service unit” means a storage system, canister, cask or container for storing nuclear material after fabrication of the system or container, post fabrication, such that the system or container has been loaded, at least in part, with nuclear material and in the monitored storage phase of the system or container life cycle.

As used herein, reference to an SAE steel grade, e.g., 316, is inclusive of the referenced grade and any sub-types or derivatives thereof, e.g., reference to grade 316 is inclusive of 316, 316F, 316L, 316N, and 316Ti, unless otherwise specified.

As used herein, the terms “optional” or “optionally” means that the subsequently described event or circumstance can or cannot occur, and that the description includes instances where said event or circumstance occurs and instances where it does not.

Defined herein throughout are various abbreviations, which include the following: (a) “CISCO” stands for “Chloride-Induced Stress Corrosion Cracking”; and (b) “SNF” stands for “Spent Nuclear Fuel.”

Unless otherwise specified, temperatures referred to herein are based on atmospheric pressure (i.e. one atmosphere).

Reference will now be made in detail to the description of the disclosure as illustrated in the drawings with like numerals indicating like parts throughout the several views. As described in detailed hereinafter, the present disclosure provides systems and methods for storing nuclear material, as defined herein, among others, that have improved resistance to CISCC, general corrosion, and/or galvanic corrosion. Although, in some aspects, the present disclosure can be described herein in relation to the storage of SNF, it should be noted that applications of the teachings of the present disclosure are not so limited, i.e., generally used in relation to storage of nuclear material. In particular, the present disclosure may be utilized in storage applications relating to any nuclear material as defined herein, including radioactive-fissile materials which may be naturally radioactive and/or radioactive due to the occurrence of a fission event(s).

In various aspects, the disclosed system for storing nuclear material comprises a storage unit, e.g., a new storage system, canister, cask or container. In some aspects, the disclosed system for storing nuclear material is a storage system for storing radioactive waste, fission products, spent nuclear fuel, nuclear fuel material, fissile material, or combinations thereof. The disclosed storage system can comprise a storage container having a wall with an outer surface, an inner surface, and an open end.

In various aspects, the disclosed systems and methods can be used to provide a coating on a storage unit, e.g., a new storage system, canister, cask or container, for nuclear material such that the coating provides protection or otherwise shields a metal substrate in the storage unit from chemical or corrosive attack, e.g., chemical attack such as chloride-induced stress corrosion cracking (“CISCC”). In a further aspect, the disclosed systems and methods can be used to provide a coating to storage unit for nuclear material that is a pre-service unit, e.g., a new storage system, canister, cask or container that has been newly manufactured or in which nuclear material has not been previously stored therein. In other aspects, the disclosed systems and methods can be used to provide a coating to storage unit for nuclear material that is an in-service unit, e.g., a storage system, canister, cask, or container that has been loaded, at least in part, with nuclear material and is in the monitored phase of the system life cycle.

In various aspects, the disclosed systems and methods for storing nuclear material can be used as a field additive manufacturing process to build up an area on a storage system, canister, cask, or container, e.g., to provide protection or otherwise shield a substrate or surface to chemical attack, e.g., CISCC. In some instances, the disclosed systems and methods for storing nuclear material can be used to build up the substrate thickness in order to provide protection or otherwise shield a substrate or surface to chemical attack, e.g., CISCC. In a further aspect, the disclosed systems and methods for storing nuclear material can further comprise machining a substrate surface to a desired thickness or contour, either before or after the field additive manufacturing process.

In various aspects, the disclosed systems and methods for storing nuclear material can be used to provide a coating on a storage unit, e.g., a new storage system, canister, cask or container, for nuclear material such that the coating provides protection or otherwise shields a metal substrate in the storage unit from chemical or corrosive attack, e.g., CISCC, that has been determined to need improved protection from CISCC, e.g., a storage unit that may be subjected to the environmental conditions that facilitate CISCC, a storage unit that has regions of tensile stress, or combinations thereof. In a further aspect, the disclosed systems and methods for storing nuclear material can be used to prevent a corrosion event.

In various aspects, the present disclosure pertains to methods for providing a protective coating to a storage system for storing nuclear material, the method comprising: depositing at least one layer of a coating material on a substrate; wherein the substrate is a surface of the storage system for storing nuclear material; wherein the coating material comprises a compatible metal powder, a compatible metal particulate, or combinations thereof; and wherein the depositing utilizes a ballistic impingement process; and thereby providing a protective coating. In some instances, the at least one layer is deposited on the outer surface. The storage system for storing nuclear material further can comprise a closure lid in sealing engagement with the container, such that the closure lid has an outer closure lid surface and an inner closure lid surface. Accordingly, it is understood, that in some instances, the at least one layer can be deposited on the outer closure lid surface.

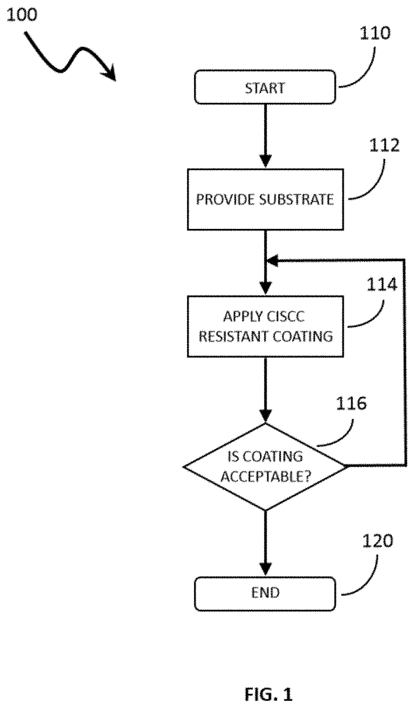

Referring now to FIG. 1, a flow diagram depicting a disclosed method 100 of the present disclosure is provided. As shown therein, the method begins at block 110 and proceeds to block 112 where an appropriate substrate is provided. Such a substrate may be provided in the form of one or more surfaces of various storage canisters, casks, or containers and/or canister, cask, or container inserts which are adapted for the storage of nuclear materials as defined herein. The storage system, canister, cask, or container can be an pre-service unit or in-service unit. The storage system, canister, cask, or container can be fabricated from a stainless steel, a ductile iron, a carbon steel, or combinations thereof. These materials are discussed in further detail with specific reference to powdered metal materials, but it is understood that these same materials can be in the form of sheets or other convenient forms for fabrication into a desired canister, cask, or container. The canister, cask, or container can be of a welded or bolted construction. In some aspects, the lid of the canister, cask, or container can be bolted or welded to thereon. Thus, the substrate referred to in block 112 may include structural and/or criticality control components utilized in storage containers and/or container inserts. For example, suitable SNF storage containers are described, but not limited to, those described in U.S. Pat. Nos. 6,544,606 and 6,784,443.

Proceeding to block 114, a CISCC-resistant coating material comprising a compatible metal powder material and optionally a hard phase material is applied to at least one surface of the provided substrate, as described in detailed hereinafter. As referred to herein, a “CISCC-resistant coating” is defined as a coating comprising a material resistant to CISCC. In particular, a CISCC-resistant coating of the present disclosure comprises a compatible metal powder material applied to the substrate using a ballistic impingement process. In a further aspect, a CISCC-resistant coating of the present disclosure comprises a compatible metal powder material and optionally a hard phase material. In various aspects, the disclosed CISCC-resistant coating can substantially prevent the conditions for initiation and propagation of CISCC due to the absence of surface tensile stress within the CISCC-resistant coating materials. In a still further aspect, the disclosed CISCC-resistant coating can be used to substantially restore or rehabilitate a substrate subjected to CISCC.

In an aspect, the compatible metal powder material comprises a powdered stainless steel, a ductile iron, a carbon steel, or combinations thereof.

In an aspect, the compatible metal powder material comprises a powdered stainless steel, such as, but not limited to, an austenitic general purpose stainless steel, an austenitic chromium-nickel-manganese ahoy, austenitic chromium-nickel alloy, a ferritic and martensitic chromium alloy, a heat-resisting chromium alloy, an austenitic steel strengthened by hot/cold work, or an austenitic super-ahoy. In a further aspect, the compatible metal powder material comprises a powdered stainless steel, such as, but not limited to, type (SAE stainless steel grade) 102, 201, 202, 205, 254, 302, 302B, 303, 303Se, 304, 304Cu, 304L, 304LN, 304N, 305, 308, 309, 310, 310S, 314, 316, 316F, 316L, 316N, 316Ti, 317, 317L, 321, 329, 330, 347, 348, 384, 405, 409, 410, 414, 416, 416Se, 420, 420F, 422, 429, 430, 431, 440A, 440B, 440C, 430F, 430FSe, 434, 436, 442, 446, 501, 502, any 600 series steel grade, any 900 series steel grade, or combinations thereof.

In a further aspect, the compatible metal powder material comprises a powdered stainless steel, such as type 600 series stainless SAE steel grade, including, but not limited to, a Martensitic low-alloy steel (type 601-604), a Martensitic secondary hardening steels (type 610-613), a Martensitic chromium steel (type 614-619), a semi-austenitic and martensitic precipitation hardening stainless steel (type 630-635), an austenitic steels strengthened by hot/cold work (type 650-653), an austenitic super-alloy (type 660-665). In a still further aspect, the compatible metal powder material comprises a powdered stainless steel such as a semi-austenitic and martensitic precipitation hardening stainless steel, e.g. type 630-635 SAE steel grade. In a yet further aspect, the compatible metal powder material comprises a powdered stainless SAE steel grade such as a type 625, a type 630, or combinations thereof.

In a further aspect, the compatible metal powder material comprises a powdered stainless steel, such as 900 series stainless SAE steel grade, including, but not limited to, a type 904, a 904L steel, or combinations thereof.

In a further aspect, the compatible metal powder comprises SAE stainless steel type 304, 310, 316, 625, 630, 904, or combinations thereof. In a further aspect, the powdered stainless steel comprises SAE stainless steel type 304. In a still further aspect, the powdered stainless steel comprises SAE stainless steel type 310. In a yet further aspect, the powdered stainless steel comprises SAE stainless steel type 316. In a further aspect, the powdered stainless steel comprises one or more SAE stainless steel types selected from 304, 310, and 316. In a still further aspect, the powdered stainless steel comprises SAE stainless steel type selected from 625, 630, and 904.

In a further aspect, the compatible metal powder material used in the ballistic impingement process comprises particles has an average size in the longest dimension of from about 5 microns to about 100 microns, about 5 microns to about 90 microns, about 5 microns to about 85 microns, about 5 microns to about 80 microns, about 5 microns to about 75 microns, about 5 microns to about 70 microns, about 5 microns to about 65 microns, about 5 microns to about 60 microns, about 5 microns to about 55 microns, about 5 microns to about 50 microns, about 5 microns to about 45 microns, about 5 microns to about 40 microns, about 5 microns to about 35 microns, about 5 microns to about 30 microns, about 5 microns to about 25 microns, about 5 microns to about 20 microns, about 5 microns to about 15 microns, about 5 microns to about 10 microns, about 10 microns to about 100 microns, about 10 microns to about 90 microns, about 10 microns to about 85 microns, about 10 microns to about 80 microns, about 10 microns to about 75 microns, about 10 microns to about 70 microns, about 10 microns to about 65 microns, about 10 microns to about 60 microns, about 10 microns to about 55 microns, about 10 microns to about 50 microns, about 10 microns to about 45 microns, about 10 microns to about 40 microns, about 10 microns to about 35 microns, about 10 microns to about 30 microns, about 10 microns to about 25 microns, about 10 microns to about 20 microns, about 10 microns to about 15 microns, about 20 microns to about 100 microns, about 20 microns to about 90 microns, about 20 microns to about 85 microns, about 20 microns to about 80 microns, about 20 microns to about 75 microns, about 20 microns to about 70 microns, about 20 microns to about 65 microns, about 20 microns to about 60 microns, about 20 microns to about 55 microns, about 20 microns to about 50 microns, about 20 microns to about 45 microns, about 20 microns to about 40 microns, about 20 microns to about 35 microns, about 20 microns to about 30 microns, about 20 microns to about 25 microns, any range or sub-range of values within the foregoing range, or any set of discrete values within the foregoing ranges. In a various further aspects, the powdered stainless steel particles have a shape that is substantially ellipsoid, spherical, irregular, or combinations thereof.

In a further aspect, the CISCC-resistant coating of the present disclosure comprises the compatible metal powder material as described herein above and one or more hard phase powder material. Without wishing to be bound by a particular theory, it is believed that in some instances a CISCC-resistant coating comprising compatible metal powder material and the one or more hard phase powder can form in situ a metal matrix composite. It is believed, without wishing to be bound by a particular theory, that such a metal matrix composite can improve the hardness of the CISCC-resistant coating, increase the adhesion strength of the CISCC-resistant coating to the substrate, and decrease the CISCC-resistant coating porosity.

In a further aspect, the one or more hard phase powder material can comprise one or more ceramic, metal oxide, ceramic/metal composite, ceramic/ceramic composite materials, or combinations thereof. Exemplary, but non-limiting ceramic and metal oxides suitable for use in the hard phase material include a zirconia (ZrO₂), alumina (Al₂O₃), Al₂O, Cr₂O₃, TiO₂, Cr₃C₂, TiC, SiC, or combinations thereof. Exemplary, but non-limiting, ceramic/metal composite materials include WC/Co, Cr₃C₂/NiCr and TiC/Fe. Exemplary, but non-limiting, ceramic/ceramic composite materials include yttria-stabilized zirconia (“YSZ”), zirconia-toughened alumina (“ZTA”), Al₂O₃/TiO₂, ZrO₂/Y₂O₃, ZrO₂/Y₂O₃—Al₂O₃, Cr₂O₃/SiO₂, and combinations thereof.

In various aspects, the compatible metal powder material and the one or more hard phase powder material can be blended together into a powder mixture which is used with the carrier gas and directed through a suitable nozzle. In other aspects, the compatible metal powder and the one or more hard phase powder material are not pre-mixed and are separately introduced to the carrier gas and directed through a suitable nozzle. In a further aspect, the carrier gas, the compatible metal powder and the one or more hard phase powder material are each directed into a chamber prior to directing through a suitable nozzle.

In a further aspect, the one or more hard phase powder material used in the ballistic impingement process comprises particles has an average size in the longest dimension of from about 5 microns to about 100 microns, about 5 microns to about 90 microns, about 5 microns to about 85 microns, about 5 microns to about 80 microns, about 5 microns to about 75 microns, about 5 microns to about 70 microns, about 5 microns to about 65 microns, about 5 microns to about 60 microns, about 5 microns to about 55 microns, about 5 microns to about 50 microns, about 5 microns to about 45 microns, about 5 microns to about 40 microns, about 5 microns to about 35 microns, about 5 microns to about 30 microns, about 5 microns to about 25 microns, about 5 microns to about 20 microns, about 5 microns to about 15 microns, about 5 microns to about 10 microns, about 10 microns to about 100 microns, about 10 microns to about 90 microns, about 10 microns to about 85 microns, about 10 microns to about 80 microns, about 10 microns to about 75 microns, about 10 microns to about 70 microns, about 10 microns to about 65 microns, about 10 microns to about 60 microns, about 10 microns to about 55 microns, about 10 microns to about 50 microns, about 10 microns to about 45 microns, about 10 microns to about 40 microns, about 10 microns to about 35 microns, about 10 microns to about 30 microns, about 10 microns to about 25 microns, about 10 microns to about 20 microns, about 10 microns to about 15 microns, about 20 microns to about 100 microns, about 20 microns to about 90 microns, about 20 microns to about 85 microns, about 20 microns to about 80 microns, about 20 microns to about 75 microns, about 20 microns to about 70 microns, about 20 microns to about 65 microns, about 20 microns to about 60 microns, about 20 microns to about 55 microns, about 20 microns to about 50 microns, about 20 microns to about 45 microns, about 20 microns to about 40 microns, about 20 microns to about 35 microns, about 20 microns to about 30 microns, about 20 microns to about 25 microns, any range or sub-range of values within the foregoing range, or any set of discrete values within the foregoing ranges. In a various further aspects, the one or more hard phase powder material particles have a shape that is substantially ellipsoid, spherical, irregular, or combinations thereof.

Thereafter, such as in block 116, a determination is made as to whether the applied coating possesses desired characteristics, such as appropriate thickness, for example, to provide the desired protection, shielding, or resistance to chemically induced degradation of a substrate or surface, e.g., CISCC. In some aspects, the coating thickness applied is about 0.001 mm to about 10 mm, any sub-range of values within the foregoing range, or any set of discrete values within the foregoing range. In other aspects, the coating thickness applied is about 0.001 inches to about 0.25 inches, any sub-range of values within the foregoing range, or any set of discrete values within the foregoing range. It is understood that a desired coating thickness can be provided in a single layer or as the aggregate coating thickness provided by multiple layers. A layer can be deposited in a single pass of a ballistic impingement process.

In a further aspect, the coating thickness applied is about 0.001 mm to about 0.005 mm, about 0.001 mm to about 0.010 mm, about 0.001 mm to about 0.020 mm, about 0.001 mm to about 0.030 mm, about 0.001 mm to about 0.040 mm, about 0.001 mm to about 0.050 mm, about 0.001 mm to about 0.060 mm, about 0.001 mm to about 0.070 mm, about 0.001 mm to about 0.080 mm, about 0.001 mm to about 0.090 mm, about 0.001 mm to about 0.100 mm, any range or sub-range of values within any of the foregoing ranges, or any set of discrete values within the foregoing ranges.

In a further aspect, the coating thickness applied is about 0.01 mm to about 10 mm, about 0.01 mm to about 9 mm, about 0.01 mm to about 8 mm, about 0.01 mm to about 7 mm, about 0.01 mm to about 6 mm, about 0.01 mm to about 5 mm, about 0.01 mm to about 4 mm, about 0.01 mm to about 3 mm, about 0.01 mm to about 2 mm, about 0.01 mm to about 1 mm, any range or sub-range of values within any of the foregoing ranges, or any set of discrete values within the foregoing ranges.

In a further aspect, the coating thickness applied is about 0.02 mm to about 10 mm, about 0.02 mm to about 9 mm, about 0.02 mm to about 8 mm, about 0.02 mm to about 7 mm, about 0.02 mm to about 6 mm, about 0.02 mm to about 5 mm, about 0.02 mm to about 4 mm, about 0.02 mm to about 3 mm, about 0.02 mm to about 2 mm, about 0.02 mm to about 1 mm, any range or sub-range of values within any of the foregoing ranges, or any set of discrete values within the foregoing ranges.

In a further aspect, the coating thickness applied is about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, any range or sub-range of values within any of the foregoing ranges, or any set of discrete values within the foregoing ranges.

In a further aspect, the coating thickness applied is about 0.5 mm to about 10 mm, about 0.5 mm to about 5 mm, about 0.5 mm to about 4 mm, about 0.5 mm to about 3 mm, about 0.5 mm to about 2 mm, any range or sub-range of values within any of the foregoing ranges, or any set of discrete values within the foregoing ranges.

In a further aspect, the coating thickness applied is about 1 mm to about 10 mm, about 1 mm to about 5 mm, about 1 mm to about 4 mm, about 1 mm to about 3 mm, about 1 mm to about 2 mm, any range or sub-range of values within the foregoing range, or any set of discrete values within the foregoing ranges.

If it is determined that the coating does not possess the desired characteristics, such as the coating has not yet achieved the desired thickness, the process may return to block 114. If, however, it is determined that the coating possesses the desired characteristics, the process may end at block 120.

As mentioned hereinbefore in regard to method 100 depicted in FIG. 1, the present disclosure includes the application of CISCC-resistant materials in the form of a coating(s) to a substrate. Such CISCC-resistant materials may include one or more elements or compounds containing desired CISCC-resistant materials characteristics while, at the same time, providing suitable properties of adhesion when applied as a coating.

Although CISCC-resistant materials may be applied to the aforementioned substrates in any suitable manner which results in a proper adhesion of the CISCC-resistant materials to the substrate, it has been determined that application of the CISCC-resistant materials through the use of ballistic impingement process provides suitable results.

As used herein, a “ballistic impingement process” generally refers to a group of processes for supersonic particle deposition of a powder or particulate material on a substrate material. A ballistic impingement process typically uses an electrically heated high-pressure carrier gas, like nitrogen or helium, to accelerate metal powders through a suitable nozzle, e.g., a supersonic de Laval nozzle, above a critical velocity for particle adhesion. Exemplary ballistic impingement processes are described in V. Champagne, D. Helfritch, P. Leyman, S. Grendahl, and B. Klotz, “Formation of ‘Super Plastic Agglomerate Mixing (SPAM) Between Copper and 6061-T6511 Aluminum Deposited by the Supersonic Deposition Process (SPD),” ASM Surface Engineering Congress, 15-18 Sep. 2003. Coatings applied by such methods typically show signs of dynamic recrystallization and formation of nano-grains at particle-particle interfaces. Moreover, coatings applied by such methods can have a high dislocation density, and accordingly, a similar or higher hardness than a substrate material comprising a similar metal as the metal in the coating material. These processes are sometimes referred to as “ultrasonic additive manufacturing processes,” “cold spray processes,” and the like.

In various aspects, the high-pressure carrier gas can be a suitable gas such as helium, nitrogen, or air, applied at a suitable velocity, e.g., about 100 m/s to about 2000 m/s, to provide supersonic particle deposition of the disclosed compatible metal powder material alone or in combination with the one or more hard phase powder material on a substrate material.

In a further aspect, the high-pressure carrier gas can be nitrogen applied at a velocity of about 300 m/s to about 400 m/s. In a particular aspect, the high-pressure carrier gas can be nitrogen applied at a velocity of about 340 m/s to about 355 m/s.

In a further aspect, the high-pressure carrier gas can be helium applied at a velocity of about 900 m/s to about 1100 m/s. In a particular aspect, the high-pressure carrier gas can be helium applied at a velocity of about 1000 m/s to about 1015 m/s.

In a further aspect, the high-pressure carrier gas is air, wherein it is understood that air comprises about 78% nitrogen, about 21% oxygen, and about 1% other gases. In instances when the high-pressure carrier gas is air, it can be applied at a velocity of about 300 m/s to about 400 m/s. In a particular aspect, the high-pressure carrier gas is nitrogen applied a velocity of about 335 m/s to about 345 m/s.

A variety of different systems and equipment can be used to perform a remanufacturing process using cold spraying according to principles of the present disclosure. In embodiments, the cold spray system can include any suitable equipment configured to perform a material deposition process in which relatively small powder particles that are in the solid state are accelerated to a relatively high velocity and applied to a surface of a substrate (or piston) to produce a layer of the powder that is adhered thereto. For example, the system used for the ballistic impingement process can include a pressurized gas source, a gas heater, a coating powder feeder and a nozzle. In various aspects, gas from the pressurized gas source is fed to the gas heater, where it can be heated. Typical gases include air, nitrogen, helium or a mixture thereof, as described above. Alternatively, the pressurized gas can be heated to the required temperature within the pressurized gas source, after mixing with the coating powder, within the nozzle, or at another location within the system. While not intended to be limited, the pressurized gas can be heated to a temperature sufficient to ensure that the particle stream that is directed to the substrate surface is between −20° C. and 700° C., between 65° C. and 550° C., between 250° C. and 550° C. The heater is preferably an electric heater, such as those commercially available in the field. Pressurized gas from the gas source can also be fed to the coating powder feeder, where stainless steel metal powder is mixed into the gas stream. Alternatively, the coating powder feeder can have its own pressurized gas source associated therewith. Typical powder feed rates are between about 10 and about 30 lbs/hr and the combined flow rate of the pressurized gas source to the heater and the powder feeder should typically be about 30 to 100 ft³/min.

The pressurized gas stream containing the stainless steel powder can then be fed to the nozzle. The nozzle is used to focus the gas stream containing the stainless steel powder particles and direct it toward the substrate surface in the form of a stream, or spray, of particles traveling at supersonic speeds. The particle velocity should typically be within the range of 300 to 1500 m/sec. Upon impacting the substrate surface, the particles are deposited by means of ballistic impingement to form a coating. Formation of the coating through this method involves mechanical mixing of the particles of the coating with the substrate material at the interface.

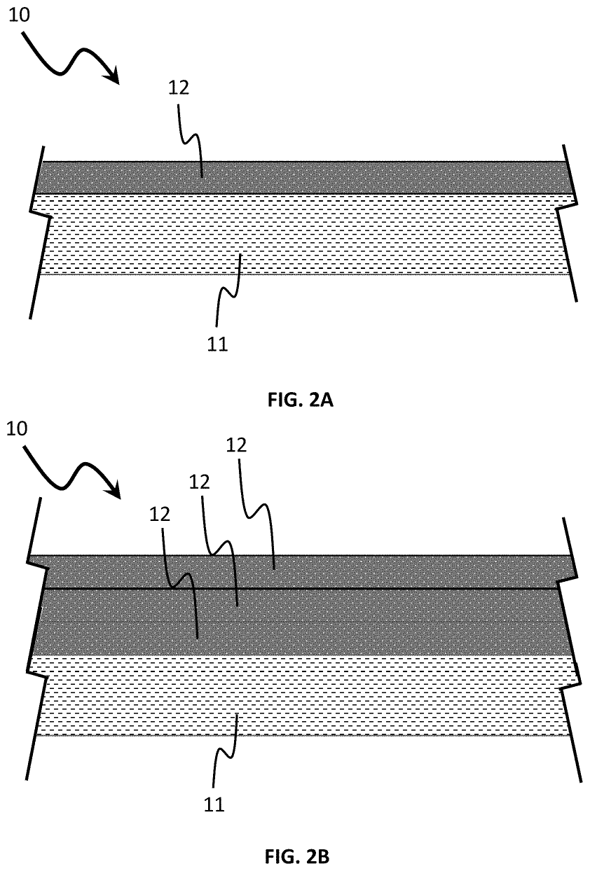

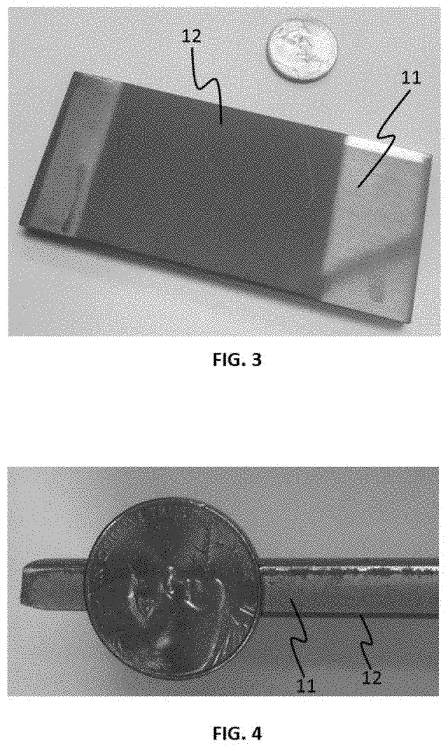

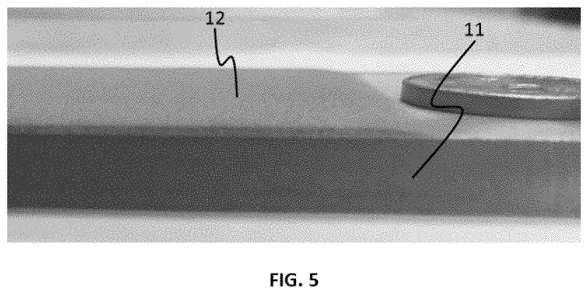

Referring now to FIGS. 2A and 2B, which show various representative cross-sectional views of a representative substrate 11 with a CISCC-resistant coating 12 formed thereon by a disclosed method. FIG. 2A shows a cross-sectional, cut-away view of a representative substrate with a single layer of a CISCC-resistant coating formed by a disclosed method. FIG. 2B shows a cross-sectional, cut-away view of a representative substrate with three layers of a CISCC-resistant coating formed by a disclosed method. Although FIG. 2B shows three layers of a CISCC-resistant coating formed by a disclosed method, it is to be understood that a plurality of layers of a CISCC-resistant coating can be formed on a representative substrate 11 using the disclosed methods. In some aspects, a plurality can be 2 to 20 layers, 2 to 19 layers, 2 to 18 layers, 2 to 17 layers, 2 to 16 layers, 2 to 15 layers, 2 to 14 layers, 2 to 13 layers, 2 to 12 layers, 2 to 13 layers, 2 to 10 layers, 2 to 9 layers, 2 to 8 layers, 2 to 7 layers, 2 to 6 layers, 2 to 5 layers, 2 to 4 layers, 3 layers, or 2 layers. In a further aspect, a representative substrate 11 can comprise one or more CISCC-resistant coating 12 layers, including 1 layer, 2 layers, 3 layers, 4 layers, 5 layers, 6 layers, 7 layers, 8 layers, 9 layers, 10 layers, 11 layers, 12 layers, 13 layers, 14 layers, 15 layers, 16 layers, 17 layers, 18 layers, 19 layers, or 20 layers; or a range of layers encompassed by any of the foregoing values. In various aspects, a CISCC-resistant coating 12 layer can comprise a compatible metal powder material and optionally a hard phase material on a substrate 11 is shown.

In various aspects, a plurality of layers of a CISCC-resistant coating can be formed on a representative substrate 11, such that each layer has a layer thickness of about 0.001 inches to about 0.25 inches, any sub-range of values within the foregoing range, or any set of discrete values within the foregoing range. It is understood that a desired layer thickness can be provided in a single layer or as the aggregate coating thickness provided by multiple layers. A layer can be deposited in a single pass of a ballistic impingement process.

In a further aspect, a plurality of layers of a CISCC-resistant coating can be formed on a representative substrate 11, such that each layer has a layer thickness of about 0.001 mm to about 0.005 mm, about 0.001 mm to about 0.010 mm, about 0.001 mm to about 0.020 mm, about 0.001 mm to about 0.030 mm, about 0.001 mm to about 0.040 mm, about 0.001 mm to about 0.050 mm, about 0.001 mm to about 0.060 mm, about 0.001 mm to about 0.070 mm, about 0.001 mm to about 0.080 mm, about 0.001 mm to about 0.090 mm, about 0.001 mm to about 0.100 mm, any range or sub-range of values within any of the foregoing ranges, or any set of discrete values within the foregoing ranges.

In a further aspect, a plurality of layers of a CISCC-resistant coating can be formed on a representative substrate 11, such that each layer has a layer thickness of about 0.01 mm to about 10 mm, about 0.01 mm to about 9 mm, about 0.01 mm to about 8 mm, about 0.01 mm to about 7 mm, about 0.01 mm to about 6 mm, about 0.01 mm to about 5 mm, about 0.01 mm to about 4 mm, about 0.01 mm to about 3 mm, about 0.01 mm to about 2 mm, about 0.01 mm to about 1 mm, any range or sub-range of values within any of the foregoing ranges, or any set of discrete values within the foregoing ranges.

In a further aspect, a plurality of layers of a CISCC-resistant coating can be formed on a representative substrate 11, such that each layer has a layer thickness of about 0.02 mm to about 10 mm, about 0.02 mm to about 9 mm, about 0.02 mm to about 8 mm, about 0.02 mm to about 7 mm, about 0.02 mm to about 6 mm, about 0.02 mm to about 5 mm, about 0.02 mm to about 4 mm, about 0.02 mm to about 3 mm, about 0.02 mm to about 2 mm, about 0.02 mm to about 1 mm, any range or sub-range of values within any of the foregoing ranges, or any set of discrete values within the foregoing ranges.

In a further aspect, a plurality of layers of a CISCC-resistant coating can be formed on a representative substrate 11, such that each layer has a layer thickness of about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, any range or sub-range of values within any of the foregoing ranges, or any set of discrete values within the foregoing ranges.

In a further aspect, a plurality of layers of a CISCC-resistant coating can be formed on a representative substrate 11, such that each layer has a layer thickness of about 0.5 mm to about 10 mm, about 0.5 mm to about 5 mm, about 0.5 mm to about 4 mm, about 0.5 mm to about 3 mm, about 0.5 mm to about 2 mm, any range or sub-range of values within any of the foregoing ranges, or any set of discrete values within the foregoing ranges.

In a further aspect, a plurality of layers of a CISCC-resistant coating can be formed on a representative substrate 11, such that each layer has a layer thickness of about 1 mm to about 10 mm, about 1 mm to about 5 mm, about 1 mm to about 4 mm, about 1 mm to about 3 mm, about 1 mm to about 2 mm, any range or sub-range of values within the foregoing range, or any set of discrete values within the foregoing ranges.

In an aspect, the substrate 11 comprises a stainless steel, a ductile iron, a carbon steel, or combinations thereof.

In an aspect, the substrate 11 comprises a stainless steel, such as, but not limited to, an austenitic general purpose stainless steel; an austenitic chromium-nickel-manganese alloy, austenitic chromium-nickel alloy, a ferritic and martensitic chromium alloy, a heat-resisting chromium alloy, an austenitic steel strengthened by hot/cold work, or an austenitic super-alloy. In a further aspect, the compatible metal powder material comprises a powdered stainless steel, such as, but not limited to, SAE stainless steel 102, 201, 202, 205, 254, 302, 302B, 303, 303Se, 304, 304Cu, 304L, 304LN, 304N, 305, 308, 309, 310, 310S, 314, 316, 316F, 316L, 316N, 316Ti, 317, 317L, 321, 329, 330, 347, 348, 384, 405, 409, 410, 414, 416, 416Se, 420, 420F, 422, 429, 430, 431, 440A, 440B, 440C, 430F, 430FSe, 434, 436, 442, 446, 501, 502, any 600 series steel grade, any 900 series steel grade or combinations thereof.

In a further aspect, the substrate 11 comprises a stainless steel, such as a SAE stainless steel type 304, 310, 316, 625, 630, 904, or combinations thereof. In a still further aspect, the substrate 11 comprises SAE stainless steel type 304. In a yet further aspect, the substrate 11 comprises SAE stainless steel type 310. In a yet further aspect, the substrate 11 comprises SAE stainless steel type 316. In an even further aspect, the substrate 11 comprises one or more SAE stainless steel types selected from 304, 310, 316, and combinations thereof. In a still further aspect, the substrate 11 comprises one or more SAE stainless steel types selected from 625, 630, 904, and combinations thereof.

In various aspects, the CISCC-resistant coating 12 comprises a stainless steel, a ductile iron, a carbon steel, or combinations thereof. As described herein, the CISCC-resistant coating 12 can formed by a disclosed ballistic impingement process using a compatible metal powder. Thus, a CISCC-resistant coating 12 comprising a stated stainless steel, a ductile iron, a carbon steel, or combinations thereof indicates that the coating was formed using a ballistic impingement process with a compatible powder comprising one or more disclosed stainless steel as appropriate for the substrate 11.

In a further aspect, the CISCC-resistant coating 12 comprises a stainless steel, such as, but not limited to, an austenitic general purpose stainless steel, an austenitic chromium-nickel-manganese alloy, austenitic chromium-nickel alloy, a ferritic and martensitic chromium ahoy, a heat-resisting chromium alloy, an austenitic steel strengthened by hot/cold work, or an austenitic super-alloy. In a still further aspect, In a further aspect, the CISCC-resistant coating 12 comprises, but not limited to, SAE stainless steel 102, 201, 202, 205, 254, 302, 302B, 303, 303Se, 304, 304Cu, 304L, 304LN, 304N, 305, 308, 309, 310, 310S, 314, 316, 316F, 316L, 316N, 316Ti, 317, 317L, 321, 329, 330, 347, 348, 384, 405, 409, 410, 414, 416, 416Se, 420, 420F, 422, 429, 430, 431, 440A, 440B, 440C, 430F, 430FSe, 434, 436, 442, 446, 501, 502, any 600 series steel grade, any 900 series steel grade, or combinations thereof.

In a further aspect, the CISCC-resistant coating 12 comprises a stainless steel, such as a SAE stainless steel type 304, 310, 316, 625, 630, 904, or combinations thereof. In a still further aspect, the CISCC-resistant coating 12 comprises SAE stainless steel type 304. In a yet further aspect, the substrate 12 comprises SAE stainless steel type 310. In a yet further aspect, the CISCC-resistant coating 12 comprises SAE stainless steel type 316. In an even further aspect, the CISCC-resistant coating 12 comprises one or more SAE stainless steel types selected from 304, 310, 316, and combinations thereof. In a still further aspect, the CISCC-resistant coating 12 comprises one or more SAE stainless steel types selected from 625, 630, 904, and combinations thereof.

In a further aspect, the CISCC-resistant coating 12 comprises a stainless steel, such as a SAE stainless steel type 304, 310, 316, 625, 904, or combinations thereof, and a hard phase material as described herein. In a still further aspect, the CISCC-resistant coating 12 comprises SAE stainless steel type 304, and a hard phase material as described herein. In a yet further aspect, the substrate 12 comprises SAE stainless steel type 310, and a hard phase material as described herein. In a yet further aspect, the CISCC-resistant coating 12 comprises SAE stainless steel type 316, and a hard phase material as described herein. In an even further aspect, the CISCC-resistant coating 12 comprises one or more SAE stainless steel types selected from 304, 310, and 316, and a hard phase material as described herein. In an even further aspect, the CISCC-resistant coating 12 comprises one or more SAE stainless steel types selected from 625, 630, 904, and combinations thereof, and a hard phase material as described herein.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for providing a protective coating to a storage system for storing nuclear material, the method comprising:
depositing at least one layer of a coating material on a substrate;
wherein the substrate is a surface of the storage system for storing nuclear material;
wherein the coating material comprises a compatible metal powder, a compatible metal particulate, or combinations thereof; and
wherein the depositing utilizes a ballistic impingement process;
thereby providing a protective coating.

2. The method of claim 1, wherein the storage system is a storage system for storing radioactive waste, fission products, spent nuclear fuel, nuclear fuel material, fissile material, or combinations thereof.

3. The method of claim 1, wherein the storage system comprises a storage container having a wall with an outer surface, an inner surface, and an open end; and wherein the at least one layer is deposited on the outer surface.

4. The method of claim 3, wherein the storage system for storing nuclear material further comprises a closure lid in sealing engagement with the container; wherein the closure lid has an outer closure lid surface and an inner closure lid surface; and wherein the at least one layer is deposited on the outer closure lid surface.

5. The method of claim 1, wherein the ballistic impingement process utilizes a carrier gas selected from helium, nitrogen, or a mixture thereof.

6. The method of claim 1, wherein the substrate comprises an SAE stainless steel type.

7. The method of claim 6, wherein the SAE stainless steel type is type 304, 310, 316, 625, 630, 904, or combinations thereof.

8. The method of claim 1, wherein the compatible metal powder comprises an SAE stainless steel type.

9. The method of claim 8, wherein the SAE stainless steel type is type 304, 310, 316, 625, 630, 904, or combinations thereof.

10. The method of claim 1, wherein the compatible metal powder comprises particles having a longest dimension of about 5 microns to about 100 microns.

11. The method of claim 1, wherein the coating material further comprises a hard phase material.

12. The method of claim 11, wherein the hard phase material is a ceramic material, metal oxide material, ceramic/metal composite material, ceramic/ceramic composite material, or combinations thereof.

13. The method of claim 12, wherein the hard phase material is material is a zirconia (ZrO₂), alumina (Al₂O₃), Al₂O, Cr₂O₃, TiO₂, Cr₃C₂, TiC, SiC, WC/Co, Cr₃C₂/NiCr, TiC/Fe, yttria-stabilized zirconia (“YSZ”), zirconia-toughened alumina (“ZTA”), Al₂O₃/TiO₂, ZrO₂/Y₂O₃, ZrO₂/Y₂O₃—Al₂O₃, Cr₂O₃/SiO₂, or combinations thereof.

14. The method of claim 1, wherein the at least one layer has a thickness of about 1 micron to about 1 mm.

15. The method of claim 1, wherein the storage system for storing nuclear material is a pre-service unit.

16. The method of claim 1, wherein the storage system for storing nuclear material is a post-service unit.

17. The method of claim 1, wherein the protective coating provides protection to chemical attack on the substrate.

18. The method of claim 17, wherein the chemical attack is CISCC.

19. A storage system comprising a component made by the method of claim 1.

20. The storage system of claim 159, wherein the storage system is a storage system for storing nuclear material.
